(19) United States
(12) Patent Application Publication
(10) Pub. No.: US 2019/0137131 A1
(43) Pub. Date: May 9, 2019

(54) AIR CONDITIONING PERFORMANCE ESTIMATION DEVICE, METHOD OF ESTIMATING AIR CONDITIONING PERFORMANCE, AND NON-TRANSITORY COMPUTER READABLE MEDIUM

(71) Applicant: KABUSHIKI KAISHA TOSHIBA, Minato-ku (JP)

(72) Inventors: Miho SAKO, Kawasaki (JP); Toru YANO, Shinagawa (JP); Hisaaki HATANO, Yokohama (JP); Hideyuki AISU, Kawasaki (JP)

(73) Assignee: KABUSHIKI KAISHA TOSHIBA, Minato-ku (JP)

(21) Appl. No.: 15/909,319

(22) Filed: Mar. 1, 2018

(30) Foreign Application Priority Data
Nov. 8, 2017 (JP) 2017-215797

(51) Int. Cl. F24F 11/47; H04W 4/38

(52) U.S. Cl. CPC F24F 11/47; F24F 2110/12; H04W 4/38

(57) ABSTRACT

An air conditioning performance estimation device includes a processor, a data estimator, and a heat quantity estimator. The processor is configured to extract data to be used for estimating a generated heat quantity among indoor equipment data which is data relating to input/output of indoor equipment, and perform processing of converting the extracted data into a format used for estimating the generated heat quantity. The data estimator is configured to estimate unacquired data from acquired data, the acquired data being different from the unacquired data, in a case where there is the unacquired data that is data not included in the indoor equipment data among data used for estimating the generated heat quantity. And the heat quantity estimator is configured to estimate the generated heat quantity on a basis of the acquired data and the estimated data.

### CROSS-REFERENCE TO RELATED APPLICATIONS

This application is based upon and claims the benefit of priority from Japanese Patent Application No. 2017-215797, filed on Nov. 8, 2017, the entire contents of which are incorporated herein by reference.

### FIELD

Embodiments described herein relate to air conditioning performance estimation device, method of estimating air conditioning performance, and non-transitory computer readable medium.

### BACKGROUND

As measures against global warming, efforts to conserve energy are positively made, and the movement of energy management utilizing IoT (Internet of Things) in environments using energy is activated. Coefficient of performance (COP), which is an indicator of energy consumption efficiency, is widely used as a performance index of air conditioning system.

A method of estimating a heat quantity of an air conditioner includes a method of measuring the heat quantity at an indoor equipment side or an outdoor equipment side. An approach focusing on the outdoor equipment side includes a compressor curve method and an outdoor side air enthalpy method. In such a method in which the measurement is made on the outdoor equipment side, since data required for estimating the heat quantity is present on the outdoor equipment side, it is difficult to acquire the data unless the special environment such as the case where checker software capable of monitoring the operation status of the equipment is supplied from the manufacturer is provided. In addition, in a case where the measurement is made on the outdoor equipment side, heat loss occurs as an error when the refrigerant or the like passes through the piping. Since this heat loss differs depending on the manufacturer, an installation situation, or the like, it is difficult to estimate the loss strictly. Furthermore, it is also known that an error occurs due to a decrease or the like in the flow rate of the refrigerant due to a leak bypass in a four-way valve.

An approach focusing on the indoor equipment side includes an indoor side air enthalpy method. In a case where the measurement is made on the indoor equipment side, it is possible to measure data relatively easily by using a building energy management system (BEMS). In some cases, however, the data of some items cannot be acquired. As exemplified above, there is a problem in that the method of estimating the heat quantity is not established, and it is difficult to estimate the heat quantity strictly.

### BRIEF DESCRIPTION OF THE DRAWINGS

FIG. 1 is a block diagram of an air conditioning performance estimation device according to an embodiment;

FIG. 2 is a diagram showing an example of an air volume instruction value and an actual air volume value;

FIG. 3 is a diagram showing an example of an instantaneous value of a required load value and a processing value;

FIG. 4 is a diagram showing an example of the instantaneous value of a temperature and a smoothed value;

FIG. 5A and FIG. 5B are diagrams showing an example of stored data;

FIG. 6 is a flowchart showing a process for estimating a generated heat quantity according to an embodiment;

FIG. 7 is a block diagram of an air conditioning performance estimation device according to another embodiment; and

FIG. 8 is a block diagram of an air conditioning performance estimation device according to another embodiment.

FIG. 9 is a diagram showing an example of an implementation of an air conditioning performance estimation device.

### DETAILED DESCRIPTION

According to one embodiment, an air conditioning performance estimation device includes a processor, a data estimator, and a heat quantity estimator. The processor is configured to extract data to be used for estimating a generated heat quantity among indoor equipment data which is data relating to input/output of indoor equipment, and perform processing of converting the extracted data into a format used for estimating the generated heat quantity. The data estimator is configured to estimate unacquired data from acquired data, the acquired data being different from the unacquired data, in a case where there is the unacquired data that is data not included in the indoor equipment data among data used for estimating the generated heat quantity. And the heat quantity estimator is configured to estimate the generated heat quantity on a basis of the acquired data and the estimated data.

Hereinafter, embodiments will be described in detail with reference to the drawings. In the following description, the temperature data and the humidity data are described separately as separate items. However, they may be acquired or processed as temperature and humidity data collectively.

### First Embodiment

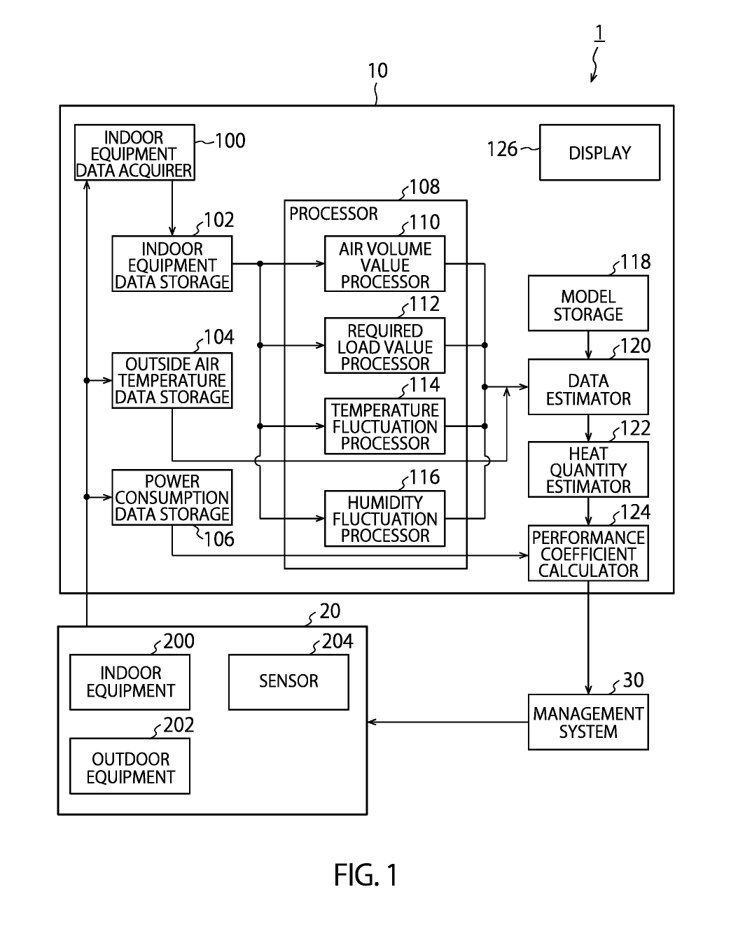

FIG. 1 is a block diagram showing functions of an air conditioning system including an air conditioning performance estimation device according to the present embodiment. An air conditioning system 1 includes an air conditioning performance estimation device 10, an air conditioner 20, and a management system 30.

The air conditioning performance estimation device 10 is a device for estimating the air conditioning performance of the air conditioner 20, and includes an indoor equipment data acquirer 100, an indoor equipment data storage 102, an outside air temperature data storage 104, a power consumption data storage 106, a processor 108, a model storage 118, a data estimator 120, a heat quantity estimator 122, and a performance coefficient calculator 124.

The indoor equipment data acquirer 100 acquires indoor equipment data that is data relating to indoor equipment 200. The indoor equipment data is, for example, data relating to input/output of the indoor equipment 200 such as an operation status, a set temperature, an air volume set value, a return air temperature, a return air humidity, a supply air temperature, and a supply air humidity along a time series of the indoor equipment 200.

The indoor equipment data storage 102 stores the indoor equipment data acquired by the indoor equipment data acquirer 100. The outside air temperature data storage 104 stores data of the outside air temperature along the time series. The power consumption data storage 106 stores data of the power consumption of the air conditioner 20 along the time series.

These storages may be configured with, for example, a database. These storages may not be provided in the air conditioning performance estimation device 10 and eventually in the air conditioning system 1. For example, a file server may be prepared externally, data may be stored in the file server, and the storages may be connected to the air conditioning performance estimation device 10 or the air conditioning system 1 via a network.

In addition, data required by the indoor equipment data acquirer 100 may be acquired from a sensor 204 provided in the air conditioner 20, or data may be acquired by the BEMS from the air conditioner 20, and the data required by the indoor equipment data acquirer 100 may be acquired from the data acquired in this BEMS.

The indoor equipment data acquirer 100 may not be provided independently, and may include, for example, an air conditioner data acquirer that collectively acquires data from the air conditioner 20. In this case, the air conditioner data acquirer may also acquire the outside air temperature data and the power consumption data all at once, and store them in each storage.

The processor 108 performs data processing for estimating the generated heat quantity of the air conditioner 20 on the basis of the data stored in the indoor equipment data storage 102. The processor 108 includes, for example, an air volume value processor 110, a required load value processor 112, a temperature fluctuation processor 114, and a humidity fluctuation processor 116.

The air volume value processor 110 extracts the data of the acquired air volume set value and performs processing for acquiring the actual air volume value from the data of the air volume set value. The air volume set value is, for example, a value set in the air conditioner 20 by a remote control or the like, which is an instruction value indicating an air volume such as a very strong wind, a strong wind, a weak wind, or the like.

The required load value processor 112 extracts the required load value from the indoor equipment data storage 102 and performs processing for converting the required load value into a format suitable for estimating the generated heat quantity. The required load value is a value that indicates how much refrigerant is required to perform air conditioning and attain the set temperature from the difference between the indoor equipment return air temperature and the set temperature of the air conditioner 20. The required load value is outputted to the outdoor equipment, and the outdoor equipment controls the pressure and the like of the refrigerant so as to dissipate heat and absorb heat, whereby the air conditioner 20 is controlled to attain the set temperature.

The temperature fluctuation processor 114 extracts time series data relating to temperature fluctuations from the indoor equipment data storage 102, and performs processing for smoothing instantaneous temperature fluctuations.

The humidity fluctuation processor 116 extracts time series data relating to humidity fluctuations from the indoor equipment data storage 102, and performs processing for smoothing instantaneous humidity fluctuations. The temperature data and the humidity data are acquired by the sensor. The acquired instantaneous values have significant fluctuations as long as they are raw data, and are not suitable for the estimating the generated heat quantity. Thus the processing of smoothing the fluctuations is performed in the processors.

The model storage 118 stores a model relating to calculation of each data when the data is estimated by the data estimator 120.

In a case where no data required for estimating the generated heat quantity is present, the data estimator 120 estimates the data that is not present from the other acquired data, that is, the various data which has been processed by the processor 108. The model stored in the model storage 118 is used for this estimation.

The heat quantity estimator 122 estimates the generated heat quantity on the basis of the data estimated by the data estimator 120 and the data processed by the processor 108. For example, an indoor side air enthalpy method is used for this estimation.

The performance coefficient calculator 124 calculates a coefficient of performance (COP) on the basis of the heat quantity estimated by the heat quantity estimator 122.

The air conditioner 20 is, for example, an air conditioner for performing indoor air conditioning, and includes the indoor equipment 200, outdoor equipment 202, and the sensor 204.

The indoor equipment 200 is installed in a room, and adjusts the temperature, humidity, and the like in the room by using the refrigerant whose heat is absorbed or dissipated by the outdoor equipment. With the indoor equipment 200, the parameters such as the set temperature, the air volume instruction value, and the like can be changed by a person present in the room using a remote control or the like. In another example, for a building or the like, the manager of the building or the like may change these parameters via the management system.

The outdoor equipment 202 is installed outdoor and adjusts the temperature of the refrigerant absorbed or released by the indoor equipment on the basis of the set temperature of the indoor equipment 200 or the like so that the temperature of the refrigerant is suitable for the set temperature by changing the pressure of the refrigerant.

The sensor 204 is installed, for example, in the air supply portion or the air return portion of the indoor equipment, and acquires information such as the return air temperature, the return air humidity, the supply air temperature, the supply air humidity and the like, and stores them in the database in the management system. Alternatively, the information detected by the sensor 204 may be acquired by the indoor equipment data acquirer 100. Further, the sensor 204 is not limited to a sensor that detects only the state of the room, but may acquire the outside air temperature data, for example.

Next, the operation of the air conditioning system 1 will be described.

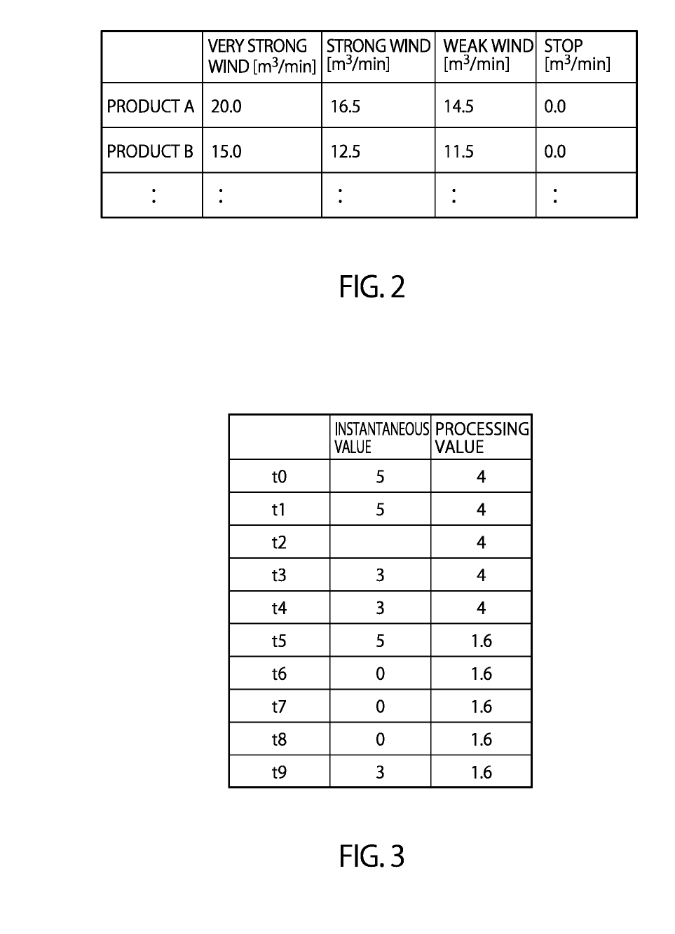

FIG. 2 is a diagram showing an example of the correspondence between the air volume instruction value and the air volume value actually outputted from the indoor equipment 200 of the air conditioner 20. For a product, the air volume value for each instruction value is set in a catalog or the like, and the air volume value processor 110 converts the air volume instruction value to the actual air volume value according to this table. For example, for the product A, an instruction value of very strong wind is an air volume such that it outputs air of 20 m³ per minute, and in the same manner, the strong wind corresponds to 16.5 m³ per minute, the weak wind corresponds to 14.5 m³ per minute, and the stop corresponds to 0 m³ per minute. The unit is not limited to this, and may be, for example, m³/hour (m³ per hour) or the like.

The air volume instruction value and the actual air volume value differ between the manufacturer, the products, etc., and the air volume instruction value and the actual air volume value of the product A are different from those of the product B. The air volume value processor 110 stores such a table as a database, for example, and on the basis of this table, the air volume value processor 110 converts data of the air volume instruction value stored in the indoor equipment data storage 102 into data of the air volume value. For example, the product and each piece of data may be linked with each other by a product name, may be linked with each other by a model number of a product. As long as the linking is uniquely determined from the product being used, any linking method may be used.

When the indoor equipment data acquirer 100 stores data relating to the air volume value into the indoor equipment data storage 102, the data may be converted and stored according to the table of FIG. 2. In this case, the air volume value processor 110 may perform a process of acquiring data of the air volume value required for estimating the generated heat quantity from the indoor equipment data storage 102.

FIG. 3 is a diagram showing an example of the instantaneous value of the required load value and the processing value after processed by the required load value processor 112. Instantaneous values of the required load value and processing values after being processed by the required load value processor 112 at times t0, t1, . . . , and t9 are shown along the time series. Here, the times t0, t1, . . . , and t9 are values measured every unit time, for example, every minute. The example shows the processing value is an average value per 5 unit time (from time t0 to time t4 and from time t5 to time t9) is calculated. The unit time is not limited to one minute. As long as it is possible to properly estimate the generated heat quantity, the time may be another predetermined time which is shorter than one minute such as one second, five seconds, or longer than one minute such as 90 seconds and two minutes.

At time t2, the instantaneous value of the required load value is not described. This indicates that the instantaneous value data was not able to be acquired due to some reason. Hereinafter, such a value that was not able to be acquired is referred to as a missing value. In a case where the missing value is present, the required load value processor 112 calculates the processing value by ignoring the instantaneous value which is the missing value and calculating the average of the other data. In this case, the average values of the instantaneous values are calculated using the values at the times t0, t1, t3, and t4. As another example, the missing value may be estimated as an average value at times t1 and t3. In addition to this, other interpolation methods, such as linear interpolation using ±2 unit time, average value interpolation, interpolation using the value of the instantaneous value (in this case, time t1) before unit time, or the like, may be applied.

The average values of the instantaneous values from the time t0 to the time t4 and from the time t5 to the time t9 are calculated and the processing value is equalized from the time t0 to the time t4 and similarly the processing value is equalized from the time t5 to the time t9. That is, the processing value from the time t0 to the time t4 is calculated as the average value of the instantaneous values from the time t0 to the time t4, which is ((5+5+3+3)/4=4), and the processing value from the time t5 to the time t9 is calculated as the average value of the instantaneous values from the time t5 to the time t9, which is (5+0+0+0+3)/5=1.6). In this example, processing is performed with a time width of five minutes. This time width value may be stored as a parameter and may be changeable by the user or the system to any other value.

The processing value is not limited to this embodiment, and it may be a moving average value at each time, or a moving average value using values obtained by calculating a standard deviation of each data as a feature quantity, and omitting data with large standard deviation. As another example, a statistic such as a mode value and a median value within a predetermined time may be extracted and used as a processing value. Other smoothing methods may be used. As described above, the required load value processor 112 extracts the instantaneous value of the required load value from the data stored in the indoor equipment data storage 102 along the time series and converts it into the processing value.

The instantaneous value of the required load value has a characteristic in which the instantaneous value overshoots greatly at the moment when the air conditioner is turned on, and tends to become small as the operating condition continues and the room temperature becomes stable. The required load value processor 112 performs processing as described above, so that it becomes possible to interpolate a locally lost values, and to acquire the processing value for which such influences of overshoot and the like are suppressed.

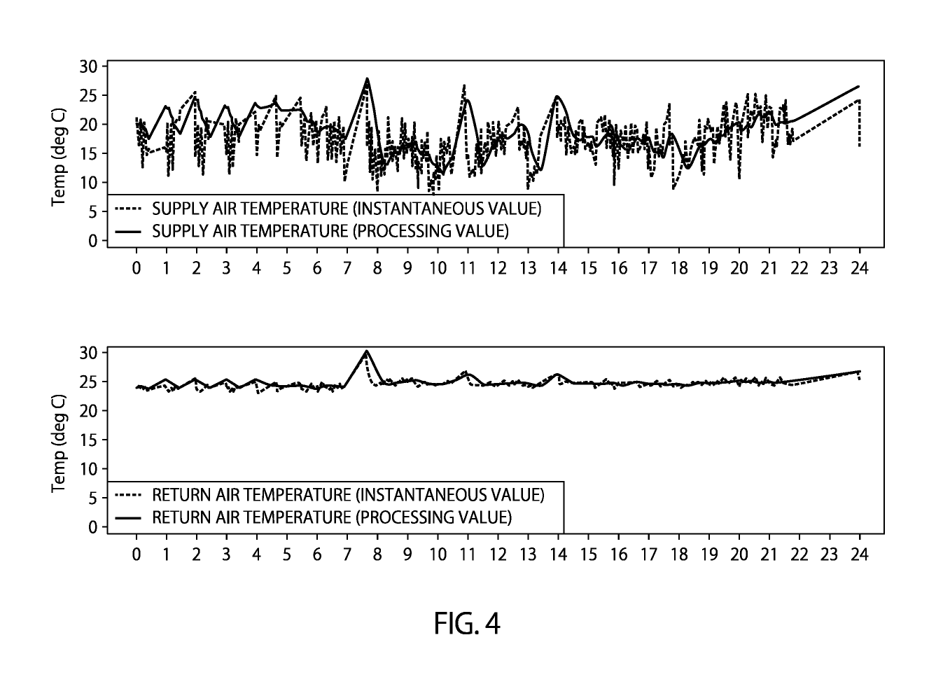

FIG. 4 is a diagram showing an example of processing in which the supply air temperature and the return air temperature are smoothed. The instantaneous values of the supply air temperature and the return air temperature largely fluctuate with time. Such fluctuations cause gross errors when estimating the generated heat quantity. Therefore, the temperature fluctuation processor 114 performs processing of smoothing the fluctuations.

The broken lines indicate instantaneous values of the supply air temperature and the return air temperature, and the solid lines indicate the smoothed values of the supply air temperature and the return air temperature. The temperature fluctuation processor 114 executes smoothing processing on instantaneous value data of the supply air temperature and the return air temperature, for example, with a unit time of one minute. In a case where there is a missing value at the timing of executing the smoothing processing, interpolation of the missing value is performed as with the above described required load value processor 112.

Smoothing is performed using, for example, a commonly used low pass filter. As an example, the moving average value with a time width of 30 minutes is calculated as a processing value. The time width may be changed on the basis of a dispersion value wherein the dispersion value for 14 minutes before and after the focused time is calculated. In this case, in a case where the dispersion value is equal to or greater than the predetermined value, a time width of 29 minutes may be used, and in a case where the dispersion value is smaller than the predetermined value, a time width of 19 minutes may be used. Further, in a case where the dispersion value is smaller than another predetermined value, that is, in a case where fluctuations of the instantaneous values do not have significant presence, smoothing processing may not be performed. As described above, the feature quantity (dispersion value in the above example) may be acquired, and parameters and the like of the smoothing processing, or a method of smoothing processing may be changed on the basis of the feature quantity.

As an example, the moving average value x bar of the data x at the time tin a case where the unit time is one minute, the time frame is 29 minutes and the missing value is ignored is expressed by the following equation.

$$\overline{x} ( t ) = \frac{x ( t - ( 30 \text{/} 2 - 1 ) ) + \cdot \cdot + x ( t ) + ⋯ x ( t + ( 30 \text{/} 2 - 1 ) )}{29 - n}$$

where, n represents the number of missing values.

For the low pass filter, the method of using the moving average value may not be applied, and other methods may be applied. Even in a case where other methods are applied, the smoothing parameter may be changed on the basis of a statistic such as the dispersion value or the like. By performing such smoothing, the broken line graph shown in FIG. 4 is converted into the solid line graph.

Since the processing relating to the humidity fluctuations performed by the humidity fluctuation processor 116 is basically the same as the processing relating to the temperature fluctuations performed by the temperature fluctuation processor 114, the detailed description will be omitted.

In the present embodiment, the generated heat quantity is estimated by a predetermined algorithm. Therefore, in a case where there is data that has not been acquired among the data required for the algorithm, the data estimator 120 estimates the unacquired data by using the data that has been processed by the processor 108. In the following, an example of calculating the generated heat quantity by the indoor side air enthalpy method as an algorithm will be described.

In the indoor side air enthalpy method, five data of the return air temperature, the return air humidity, the supply air temperature, the supply air humidity, and the air volume are required for estimating the generated heat quantity. Therefore, first of all, the data estimator 120 decides whether these five pieces of data are acquired and properly processed by the processor 108. Generally, since it is difficult to acquire data relating to the supply air temperature of the indoor equipment 200, as an example, a case where the supply air temperature cannot be acquired will be described.

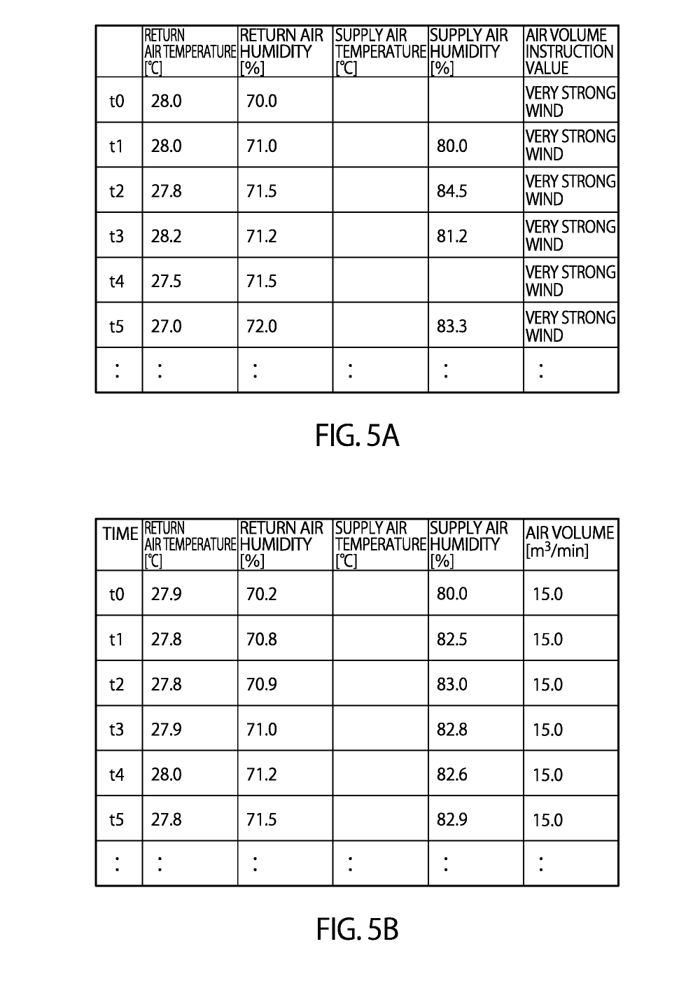

FIG. 5A is a diagram showing an example of the return air temperature, the return air humidity, the supply air temperature, the supply air humidity, and the air volume instruction value stored in the indoor equipment data storage 102 along the time series from the time t0. Blanks in the table indicate missing values or data that has not been acquired. In this example, although the data of the return air temperature, the return air humidity, the supply air humidity, and the air volume instruction value are stored, the supply air temperature is not stored.

For example, the data relating to the time for estimating the generated heat quantity is extracted, and it is determined that for each piece of data, in a case where the loss is less than 50%, the data has been acquired, and in a case where the loss is 50% or more, the data has not been acquired. It is determined that the supply air temperature has not been acquired from the indoor equipment data storage 102 because the loss of the supply air temperature data is 50% or more. It is decided that it is necessary to perform estimation of this supply air temperature from other data.

From this data, the processor 108 acquires the smoothed data as data suitable for estimation of the generated heat quantity in the processor for each data. FIG. 5B is a diagram showing data processed in the processor. The smoothing method is described above, and another smoothing method may be used depending on data.

Note that the items extracted here are not necessarily five items in the present embodiment, and the items may be changed according to the method to be used, or as in the second embodiment described later, the algorithm for estimating the generated heat quantity may be changed on the basis of the extracted data.

The data estimator 120 estimates the data of the supply air temperature acquired via the processor 108 as described above from the other data similarly acquired via the processor 108. As an example, the data of the supply air temperature is estimated by linear regression analysis from related data such as the set temperature, the return air temperature, the return air humidity, the supply air humidity, the required load value, the air volume, the outside air temperature and the like.

The data estimator 120 acquires a linear regression analysis model for estimating the supply air temperature from the set temperature, the return air temperature, the return air humidity, the supply air humidity, the required load value, the air volume, and the outside air temperature stored in the model storage 118, and estimates the supply air temperature on the basis of the data processed by the processor 108 or acquired from the indoor equipment data storage 102 using the model.

As an example, the supply air temperature x (t) at the time t is calculated by the following equation: the supply air temperature×(t)=a1× set temperature (t)+a2× return air temperature (t)+a3× return air humidity (t)+a4× outside air temperature (t)+a5× air volume (t)+a6× required load value (t)+a7. For example, the data to be used (the set temperature, the return air temperature, the return air humidity, the outside air temperature, the air volume, the required load value in the above case) and the coefficients a1, a2, . . . , and a7 (including constants) of each data are associated with each data, and stored in the model storage 118.

In a case where the above data has not been acquired, when another data set and the coefficients b1, . . . , etc. which are associated with each of the another data set are stored, it is also possible to estimate the supply air temperature using the another data set and the coefficients b1, . . . .

What is stored as a model is not limited to a linear function, and a more complicated estimation model may be stored. In that case, coefficients, exponents, estimation formulas, or the like for each data may be stored. In this manner, the data estimator 120 extracts an estimation model in the model storage 118 on the basis of the data stored in the indoor equipment data storage 102, and estimates data that has not been acquired.

In a case where an algorithm used for estimation of the generated heat quantity is preset, the model storage stores information with respect to which data among the data sets required for the algorithm can be estimated by using which data. The estimation method may not be limited to one method. For example, in the above example, a model that can estimate the supply air temperature may be stored even in a case where supply air humidity data has not been acquired. In addition, in a case where there is an alternative variable that can replace an unacquired variable, the alternative variable can be associated with the unacquired variable, and can replace the unacquired variable.

“In a case where the supply air temperature is estimated by the data estimator 120, the heat quantity estimator 122 executes estimation of the generated heat quantity. For example, in the indoor side air enthalpy method, the generated heat quantity is estimated on the basis of the following equation. The equation is expressed as

$$general heat quantity = \frac{\begin{matrix}air volume value \times \\ \vert suction air specific enthalpy - \\ blowing air specific enthalpy \vert\end{matrix}}{\begin{matrix}blowing air specific volume \times \\ ( 1 + blowing air absolute humidity )\end{matrix}}$$

The return air specific enthalpy and the supply air specific enthalpy are expressed by the following equation.

$$specific enthalpy = CP\_AIR \times temperature + absolute humidity \times ( R 0 + CP\_VAPOR \times temperature )$$

$$absolute humidity = \frac{0.622 \times relative humidity}{100} \times \frac{saturated water vapor pressure}{ATM - \frac{relative humidity \times saturated water vapor pressure}{100}}$$

$$saturated water vapor pressure = \frac{6.1078 \times {10}^{⋀} ( 7.5 \times \frac{temperature}{temperature + 237.3} )}{10}$$

$$blowing air specific volume = R\_VAPOR \times \frac{\begin{matrix}( R\_RATIO + blowing air absolute humidity ) \times \\ ( blowing air temperature + TCONV )\end{matrix}}{moist air total pressure}$$

where in the case of the return air specific enthalpy, the return air temperature is used as the temperature and the return air humidity is used as the humidity, and in the case of the supply air specific enthalpy, the supply air temperature is used as the temperature and the supply air humidity is used as the humidity. Each humidity data (return air humidity or supply air humidity) processed by the processor 108 is used as the relative humidity. For example, the moist air total pressure is the atmospheric pressure, which is denoted as ATM.

In the above equation, each parameter is as follows:

CP_AIR (specific heat performance at constant pressure of dry air)=1.00

CP_VAPOR (specific heat performance at constant pressure of water vapor)=1.805

TCONV (conversion constant of absolute temperature and centigrade temperature)=273.15

R0 (latent heat of vaporization of water at 0° C.)=2.501

ATM (1 atm)=101.325

R_AIR (gas constant of dry air)=287.0×10̂(−3)

R_VAPOR (gas constant of water vapor)=461.5×10̂(−3)

R_RATIO (a ratio of gas constant of dry air to gas constant of water vapor)=R_AIR/R_VAPOR=0.62198

The performance coefficient calculator 124 calculates the coefficient of performance which is defined as (coefficient of performance)=(generated heat quantity)/(power consumption), and outputs it to the management system 30 on the basis of the estimated heat quantity of the air conditioner 20 estimated by the heat quantity estimator 122 and the power consumption data stored in the power consumption data storage 106. The management system 30 in the air conditioning system 1 executes air conditioning control to manage the air conditioner 20, that is, perform energy saving setting, on the basis of this coefficient of performance. Although the air conditioning performance estimation device 10 and the management system 30 are illustrated as separate devices, as another example, the management system 30 may include the air conditioning performance estimation device 10.

The estimated generated heat quantity and the calculated coefficient of performance may be outputted to and displayed on a display 126 together with other data, so that they are manageable by the user. In addition, the air conditioning performance estimation device 10 does not necessarily include the performance coefficient calculator 124, and the air conditioning performance estimation device 10 may estimate the generated heat quantity and output the estimated generated heat quantity to the management system 30. Then, the management system 30 may convert it into the coefficient of performance or other index to be required.

The data to be displayed on the display 126 includes not only data relating to the generated heat quantity and the coefficient of performance but also other data such as data relating to the relation between data which has not been acquired and data used for the estimation of the unacquired data, data relating to before and after processing the acquired data by the processor 108, and the like. In addition, a manipulator (not shown) may be provided, so that the user can perform manipulations such as adjustment of each parameter while browsing the display 126. Further, execution of recalculation of the calculated data, execution of energy saving control of the air conditioner 20, etc. may be selectably displayed on the display 126 and these manipulations may be performed by an input from the manipulator.

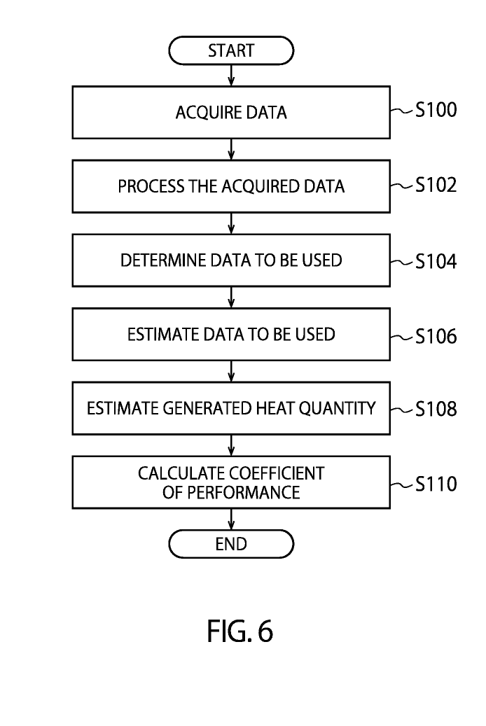

Next, the above-described operation will be described as the flow of processing of each section. FIG. 6 is a flowchart showing the flow of processing.

First, the processor 108 acquires various data stored in the indoor equipment data storage 102 (S100).

Next, the processor 108 performs processing of the acquired data on the basis of the type of data (S102). Processing of the acquired data may be performed in parallel for each data or sequentially in order.

Next, the data estimator 120 determines data to be used for the algorithm on the basis of the data processed by the processor 108 and the data acquired from the indoor equipment data storage 102 (S104).

Next, the data estimator 120 estimates unacquired data in a case where there is the unacquired data that has not been acquired among the data to be used (S106). In a case where there is a plurality of unacquired data, estimation processing of these data may be performed in parallel for each data or sequentially in order.

Next, the heat quantity estimator 122 estimates the generated heat quantity on the basis of the data processed by the processor 108, the data acquired from the indoor equipment data storage 102, and the data estimated by the data estimator 120 (S108).

Next, the performance coefficient calculator 124 calculates a coefficient of performance on the basis of the generated heat quantity estimated by the heat quantity estimator 122, outputs the coefficient of performance (S110), and terminates the processing.

In this manner, the generated heat quantity of the air conditioner 20 is estimated on the basis of the data acquired by the sensor 204 of the air conditioner 20, and the coefficient of performance that can be used for the energy saving operation is calculated.

As described above, according to the present embodiment, data estimation is performed on the basis of data that is easy to acquire or data that can be estimated more accurately, so that estimation of the generated heat quantity of the air conditioner 20 can be easily and more accurately performed. For example, the indoor side air enthalpy method makes it possible to estimate the generated heat quantity more accurately than a method in which loss occurs when refrigerant or the like works between the indoor equipment 200 and the outdoor equipment 202.

As described above, even in a case where the measurement items detected by the sensors in the indoor equipment or the outdoor equipment are not sufficient in calculating the performance index of the air conditioner 20, missing data items are estimated on the basis of the data items stored in the BEMS, and the air conditioning performance calculated using the estimated data, so that it is possible to calculate the performance index even in the air conditioner 20 having no sensor required for estimating the generated heat quantity. Furthermore, performing the processing such as appropriate smoothing processing of the data that is difficult to estimate when using an actual measurement value makes it possible to perform interpolation of data and estimation of the generated heat quantity without difficulty.

Moreover, such data interpolation has wide versatility of data to be handled and can be applied to a wide variety of air conditioning systems having BEMS. The algorithm to be used is not limited to the indoor side air enthalpy method. For example, it is possible to use other methods such as an outdoor side air enthalpy method, a compressor curve method, and the like. In this case, the required data is different from those described above. However, even in a case where there is unacquired data among data required for estimating the generated heat quantity, a model in which the generated heat quantity can be estimated from the data that has been acquired is generated and stored in the model storage 118, making it possible to estimate the generated heat quantity. In this way, it is possible to estimate the generated heat quantity using data that can be accurately and easily acquired.

### Second Embodiment

In the embodiment described above, the description is made in which the estimation of the generated heat quantity is performed by interpolating data required for a predetermined algorithm from other data. In the present embodiment, the algorithm is also determined from the acquired data.

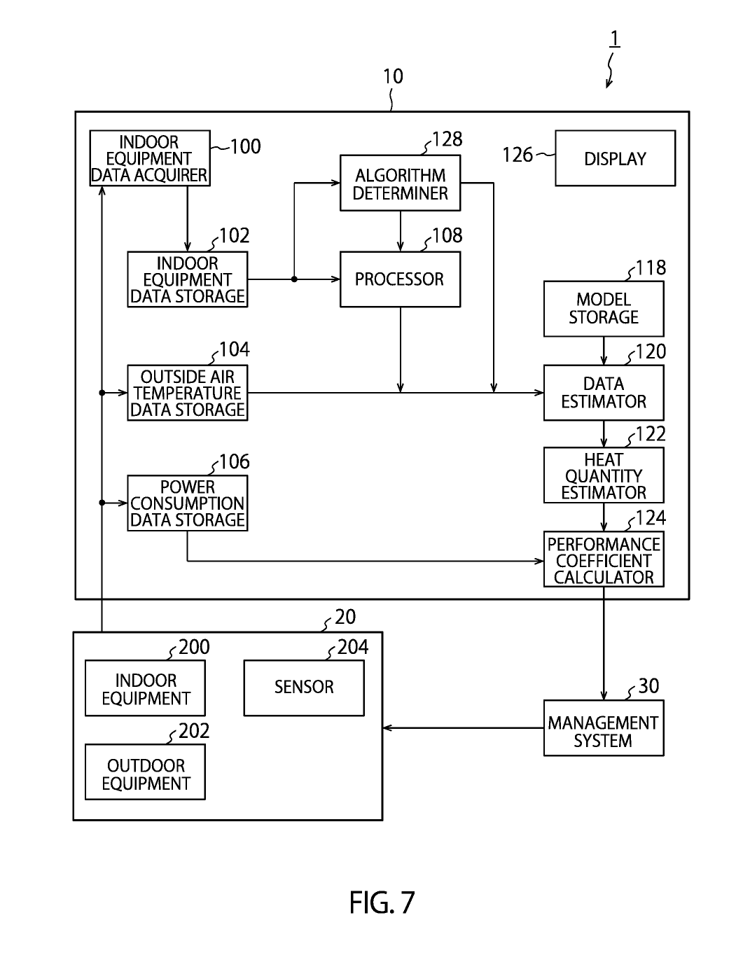

FIG. 7 is a block diagram showing functions of the air conditioning system 1 including the air conditioning performance estimation device 10 according to the present embodiment. The air conditioning performance estimation device 10 according to the present embodiment further includes an algorithm determiner 128. Although the content of the processor 108 is not shown, a data processor for processing required data as appropriate is provided.

The algorithm determiner 128 is connected to the indoor equipment data storage 102 and the data estimator 120, and determines an algorithm that can estimate the generated heat quantity on the basis of the data stored in the indoor equipment data storage 102 or the like. Further, the algorithm determiner 128 may be also connected to the processor 108, and may output the type of data that causes the processor 108 to perform processing on the basis of the determined algorithm.

For example, in a case where data of five items of the return air temperature, the return air humidity, the supply air temperature, the supply air humidity, and the air volume are stored in the indoor equipment data storage 102, the algorithm determiner 128 determines the indoor side air enthalpy method is applied as an algorithm for estimating the generated heat quantity. Even in a case where data relating to the supply air temperature has not been acquired, in view of the fact that the supply air temperature can be estimated from other data, it may be determined that the indoor side air enthalpy method is applied as a generated heat quantity estimation algorithm.

In this manner, in a case where an algorithm relating to heat quantity generation, a data group required for the algorithm, and data missing in the data group are present, the algorithm determiner 128 stores a link with respect to which data of the above data allows the data estimator 120 to estimate missing data, and determines an algorithm for estimating heat quantity generation on the basis of the data stored in the indoor equipment data storage 102.

Note that the link between the algorithm, the data, and the like is not stored exclusively in the algorithm determiner 128. The air conditioning performance estimation device 10 may have another database of the link, or the link stored in external server may be used. In addition, priority may be provided to the algorithm to be used, and it may be determined whether the algorithms can be used on the basis of data that is present in descending order of priority.

For example, suppose that in a case where the data stored in the indoor equipment data storage 102 is the data A, B, C, D, and E, the state quantities required for a certain algorithm are data A, B, and F. In a case where the data F can be estimated from the data C and D, the algorithm determiner 128 decides that the certain algorithm can be applied, and in a case where there is no other useful algorithm, the algorithm is determined as the generated heat quantity estimation algorithm.

As another example, in a case where the data F can be replaced by the data E, the algorithm determiner 128 determines that the certain algorithm is applied using the data A, B, and E. As still another example, in a case where the state quantities required for a certain another algorithm are data A, F, and G, in a case where the data F and G can be estimated or replaced using the data A, B, C, D, E, the certain another algorithm may be determined as the generated heat quantity estimation algorithm.

As described above, according to the present embodiment, an algorithm used for heat quantity generation is automatically determined on the basis of data detected by the sensor 204 of the air conditioner 20. In this case, in a case where the sensor 204 does not detect the data required for the algorithm, the algorithm to be used is determined by further taking into consideration the data that can be estimated by the data estimator 120 from the detected data.

### Third Embodiment

In the previous embodiments, the generated heat quantity is estimated without taking into consideration a shift of the time series data. On the other hand, the air conditioning performance estimation device 10 according to the present embodiment corrects a time shift in a case where there is the time shift between acquired data.

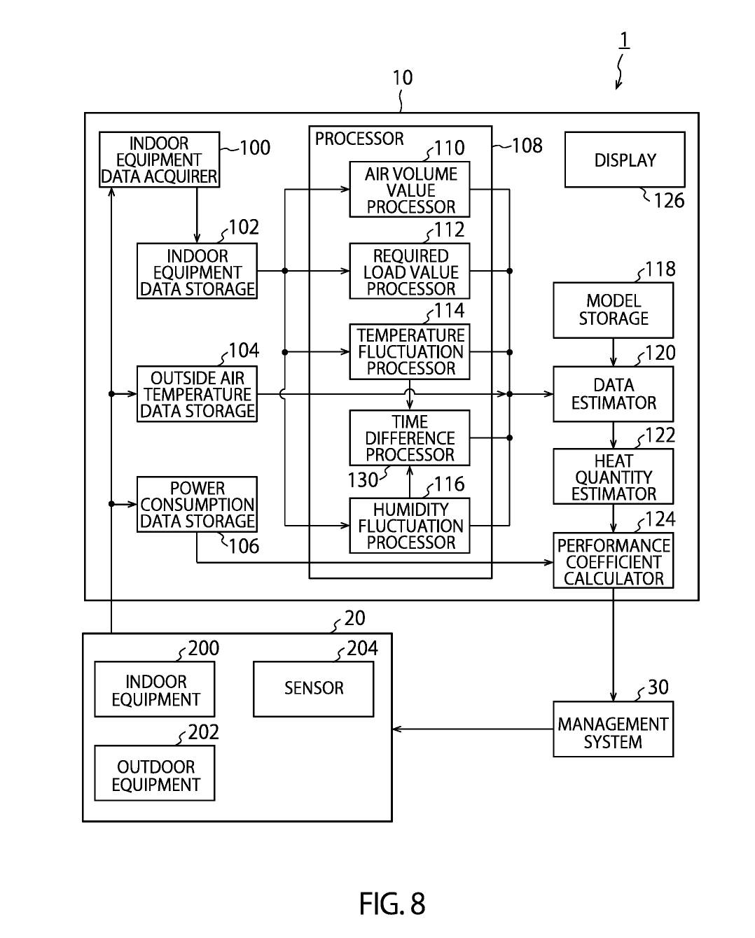

FIG. 8 is a block diagram showing functions of the air conditioning system 1 including the air conditioning performance estimation device 10 according to the present embodiment. The air conditioning performance estimation device 10 includes the processor 108 and further a time difference processor 130.

In a case where there is a time shift (time difference) between the data, the time difference processor 130 performs processing of correcting the data in the time axis direction so as to correct the time shift. This time shift occurs, for example, due to the installation of refrigerant piping or air piping in the air conditioner 20. In such a case, the time difference processor 130 corrects the time shift between the two data.

The correction is performed by shifting the data in the time axis direction in a case where a physical distance exists between sensors that acquires temperature data or humidity data, and the time shift due to the distance appears in the data. The time difference processor 130 calculates the cross-correlation coefficient of two data, for example, and corrects the time shift so that the cross-correlation coefficient becomes the maximum value.

For example, the cross-correlation coefficient c (T) of two data series x (t) and y (t) is expressed by the following equation.

$$c ( τ ) = \frac{{\sum }_{t = 1}^{N - τ} ( x ( t ) - \overline{x} ) ( y ( t + τ ) - \overline{y} )}{\sqrt{{\sum }_{t = 1}^{N - τ} {( x ( t ) - \overline{x} )}^{2}} \sqrt{{\sum }_{t = 1}^{N - τ} {( y ( t + τ ) - \overline{y} )}^{2}}}$$

where N is the size of the window when calculating the cross-correlation, and x bar and y bar are the average values of x and y, respectively.

As an example, in a case of estimating the generated heat quantity by the indoor side air enthalpy method, in some cases it is be difficult to detect the supply air temperature of the indoor equipment 200 in real time. In such a case, the supply air temperature of the indoor equipment 200 is measured for a certain period of time in advance. The time difference processor 130 calculates the cross-correlation coefficient with the estimated supply air temperature based on the data detected by the sensor of the outdoor equipment measured wherein the data is measured within the same time period and performs processing so as to shift the time series so that the correlation coefficient becomes the largest.

In this case, for example, in a case where it is obvious that an error of 20 minutes does not occur even due to the time shift caused by the piping, the cross-correlation coefficient is calculated by shifting every minute from −20 minutes to +20 minutes. Then, the time difference processor 130 extracts the time at which the cross-correlation coefficient represents the largest value out of the calculated 41 cross-correlation coefficients as a shifted time, and shifts the time corresponding to the shifted time, whereby the time shift of other data and supply air temperature is adjusted.

The above adjustment is not limited to the case where the time shift can be measured in advance. That is, the time shift may be calculated from the correlation coefficient for a plurality of data in which relationship where the correlation exists is obvious among the data stored in the indoor equipment data storage 102. In addition, the time shift of data other than the supply air temperature may be calculated.

The subsequent operation is the same as that of each embodiments described above.

As described above, according to the present embodiment, even in the case where the time shift occurs every data or between data, it is possible to correct the time shift and more accurately estimate the generated heat quantity.

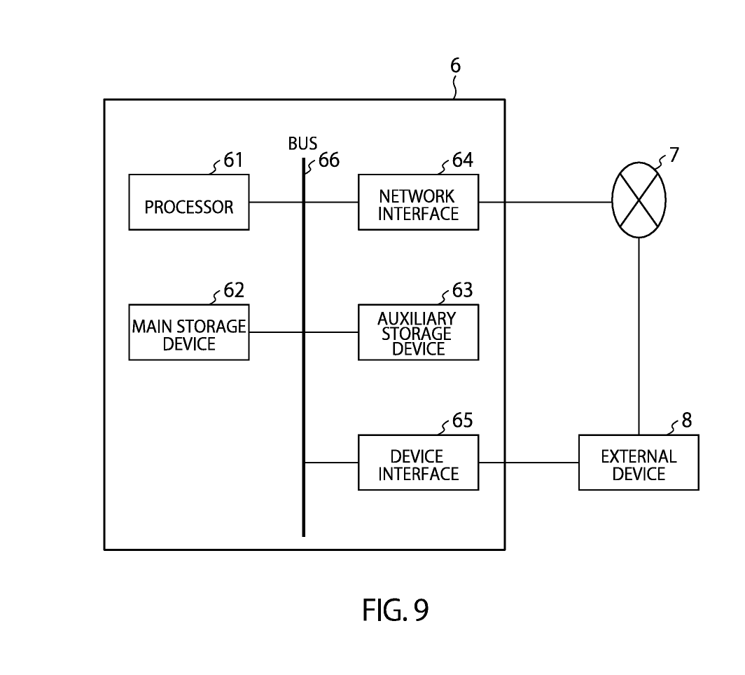

FIG. 9 is a block diagram illustrating an example of a hardware configuration according to an embodiment. An air conditioning performance estimation device 10 can be implemented as a computer device 6 including a processor 61, a main storage device 62, an auxiliary storage device 63, a network interface 64, and a device interface 65, which are connected together via a bus 66. In addition, the air conditioning performance estimation device 10 may further include an input device 67 and an output device 68.

The air conditioning performance estimation device 10 according to the present embodiment may be implemented by installing in advance a program executed in each device in the computer device 6, or by storing the program in a storage medium such as a CD-ROM, or distributing the program via a network, and installing the program in the computer device 6 as appropriate.

The computer device 6 includes each one of the constituents; however, the computer 6 may have a plurality of the same constituents. In addition, one computer device is illustrated; however, software may be installed in a plurality of the computer devices. Each of the plurality of computer devices may execute processing of a different part of the software to generate a processing result. That is, the data processing device may be configured as a system.

The processor 61 is an electronic circuit including a control device and a computing device of a computer. The processor 61 performs arithmetic processing on the basis of data and programs input from each device or the like of the internal configuration of the computer device 6, and outputs calculation results and control signals to each device or the like. Specifically, the processor 61 executes an operating system (OS) of the computer device 6, an application, and the like, and controls devices configuring the computer device 6.

The processor 61 is not particularly limited to this as far as the processing described above can be performed. The processor 61 may be, for example, a general purpose processor, a central processing unit (CPU), a microprocessor, a digital signal processor (DSP), a controller, a microcontroller, a state machine, or the like. In addition, the processor 61 may be incorporated in an application specific integrated circuit (ASIC), a field-programmable gate array (FPGA), or a programmable logic device (PLD). In addition, the processor 61 may be configured from a plurality of processing devices. For example, the processor 61 may be a combination of the DSP and the microprocessor, or may be one or more microprocessors working with a DSP core.

The main storage device 62 is a storage device that stores instructions executed by the processor 61, various data, and the like, and information stored in the main storage device 62 is directly read by the processor 61. The auxiliary storage device 63 is a storage device other than the main storage device 62. The storage device is intended to mean any electronic component capable of storing electronic information. Volatile memory used for temporary storage of information such as random access memory (RAM), dynamic RAM (DRAM), or static RAM (SRAM) is mainly used as the main storage device 62; however, in the embodiment of the present invention, the main storage device 62 is not limited to these volatile memories. The storage device used as the main storage device 62 and the auxiliary storage device 63 each may be a volatile memory or a nonvolatile memory. The nonvolatile memory is programmable read only memory (PROM), erasable PROM (EPROM), non-volatile RAM (NVRAM), magnetoresistive RAM (MRAM), flash memory, or the like. As the auxiliary storage device 63, magnetic or optical data storage may be used. As the data storage, a magnetic disk such as a hard disk, an optical disk such as a DVD, a flash memory such as a USB memory, a magnetic tape, or the like may be used.

If the processor 61 reads or writes information directly or indirectly to the main storage device 62 or the auxiliary storage device 63, or both, it can be said that the storage device communicates electrically with the processor. The main storage device 62 may be integrated in the processor. Also in this case, it can be said that the main storage device 62 communicates electrically with the processor.

The network interface 64 is an interface for connecting to a communication network by wireless or wire. As for the network interface 64, one conforming to the existing communication standard can be used. An output result or the like may be transmitted to an external device 8 communicably connected via a communication network 7 by the network interface 64.

The device interface 65 is an interface such as USB connected to the external device 8 that records the output result and the like. The external device 8 may be an external storage medium or a storage such as a database. The external storage medium may be any arbitrary storage medium such as a HDD, CD-R, CD-RW, DVD-RAM, DVD-R, storage area network (SAN) and the like. Alternatively, the external device 8 may be an output device. The output device is, for example, a liquid crystal display (LCD), a cathode ray tube (CRT), a plasma display panel (PDP), a speaker, or the like, but it is not limited thereto.

Part or all of the computer device 6, that is, part or all of the data processing device may be configured by a dedicated electronic circuit (hardware) such as a semiconductor integrated circuit on which the processor 61 and the like are mounted. The dedicated hardware may be configured in combination with the storage device such as the RAM, ROM, and the like.

In FIG. 9, one computer device is illustrated; however, software may be installed in a plurality of the computer devices. Each of the plurality of computer devices may execute processing of a different part of the software to generate a processing result.

In the description above, an air conditioning performance estimation device 10 can be implemented as a computer device in FIG. 9, it is not limited to this condition. For example, an air conditioning system 1 is configured like the computer device 6 showin in FIG.9, an air conditioning performance estimation device 10 is configured by a software described by a program stored in the auxiliary storage device 63, and information processing by the software may be specifically realized by using hardware resources.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An air conditioning performance estimation device comprising:
a processor configured to extract data to be used for estimating a generated heat quantity among indoor equipment data which is data relating to input/output of indoor equipment, and perform processing of converting the extracted data into a format used for estimating the generated heat quantity;
a data estimator configured to estimate unacquired data from acquired data, the acquired data being different from the unacquired data, in a case where there is the unacquired data that is data not included in the indoor equipment data among data used for estimating the generated heat quantity; and
a heat quantity estimator configured to estimate the generated heat quantity on a basis of the acquired data and the estimated data.

2. The air conditioning performance estimation device according to claim 1, wherein the processor includes an air volume value processor configured to extract an air volume instruction value from the indoor equipment data to acquire an air volume value on a basis of the air volume instruction value.

3. The air conditioning performance estimation device according to claim 1, wherein the processor includes a required load value processor configured to extract and smooth a required load value which is a required value of a refrigerant from the indoor equipment data.

4. The air conditioning performance estimation device according to claim 1, wherein the processor includes a temperature fluctuation processor configured to extract and smooth data relating to temperature from the indoor equipment data.

5. The air conditioning performance estimation device according to claim 1, wherein the processor includes a humidity fluctuation processor configured to extract and smooth data relating to humidity from the indoor equipment data.

6. The air conditioning performance estimation device according to claim 1, wherein the processor processes data by omitting a missing value in a case where there is the missing value in a time series of each extracted data.

7. The air conditioning performance estimation device according to claim 1, wherein the processor estimates a value corresponding to a missing value on a basis of data that is present before and after the missing value in the acquired data in a case where there is the missing value in a time series of each extracted data.

8. The air conditioning performance estimation device according to claim 1, wherein in a case where there is the unacquired data among data required for estimating the generated heat quantity, and in a case where the unacquired data can be replaced with the acquired data, the acquired data being different from the unacquired data, the data estimator estimates the generated heat quantity using the acquired data that can replace the unacquired data as the unacquired data.

9. The air conditioning performance estimation device according to claim 1,
wherein in a case where there is the unacquired data among data of an air volume value, a return air temperature value, a return air humidity value, a supply air temperature value, and a supply air humidity value, the data estimator estimates the unacquired data from the acquired data, the acquired data being different from the unacquired data, and
the heat quantity estimator estimates the generated heat quantity by an indoor side air enthalpy method on a basis of the air volume value, the return air temperature value, the return air humidity value, the supply air temperature value, and the supply air humidity value that have been acquired or estimated.

10. The air conditioning performance estimation device according to claim 9, wherein the data estimator estimates a value on a basis of a predetermined model for the unacquired data in a case of estimating the unacquired data.

11. The air conditioning performance estimation device according to claim 1, further comprising an algorithm determiner configured to determine an algorithm for executing estimation of the generated heat quantity on a basis of the indoor equipment data,
wherein the data estimator estimates data that has not been acquired among data to be used in the algorithm determined by the algorithm determiner, and
wherein the heat quantity estimator estimates the generated heat quantity on a basis of the algorithm determined by the algorithm determiner.

12. The air conditioning performance estimation device according to claim 1, further comprising a time difference corrector configured to correct a time shift between data having the time shift among the indoor equipment data.

13. The air conditioning performance estimation device according to claim 12, wherein the time difference corrector calculates a correlation coefficient along a time series with respect to correlated data, and corrects the time shift so that the correlation coefficient becomes higher.

14. The air conditioning performance estimation device according to claim 1, further comprising a performance coefficient calculator configured to calculate a coefficient of performance on a basis of power consumption data and the generated heat quantity estimated by the heat quantity estimator.

15. A method of estimating air conditioning performance comprising:
extracting data to be used for estimating a generated heat quantity among indoor equipment data which is data relating to input/output of indoor equipment, and performing processing of converting the extracted data into a format used for estimating the generated heat quantity;
estimating unacquired data from the indoor equipment data in a case where there is the unacquired data that is data not included in the indoor equipment data among data used for estimating the generated heat quantity; and
estimating the generated heat quantity on a basis of the acquired data and the estimated data.

16. A non-transitory computer readable medium storing a program that causes a computer to function as:
an extractor-converter configured to extract data to be used for estimating a generated heat quantity among indoor equipment data which is data relating to input/output of indoor equipment, and perform processing of converting the extracted data into a format used for estimating the generated heat quantity;
an estimator configured to estimate unacquired data from the indoor equipment data in a case where there is the unacquired data that is data not included in the indoor equipment data among data used for estimating the generated heat quantity; and
an estimator configured to estimate the generated heat quantity on a basis of acquired data and the estimated data.
